(19) United States
(12) Patent Application Publication
(10) Pub. No.: US 2020/0030675 A1
(43) Pub. Date: Jan. 30, 2020

(54) TOWEL RACK FOR USE DURING SPORTS EVENT

(71) Applicant: Group One Limited, Ramsey (GB)

(72) Inventor: Fredric Goldstein, Nacka (SE)

(21) Appl. No.: 16/592,246

(22) Filed: Oct. 3, 2019

Related U.S. Application Data
(63) Continuation-in-part of application No. 15/957,059, filed on Apr. 19, 2018.
Application No. 15/957,059 is a continuation of application No. 14/351,725, filed on Apr. 14, 2014, now Pat. No. 9,975,023.
(60) Provisional application No. 61/546,589, filed on Oct. 13, 2011.
(60) Provisional application No. 61/564,496, filed on Nov. 29, 2011.

(51) Int. Cl. A63B 61/00; A63B 71/06; G09F 23/00; G09F 9/30; A47K 10/10

(52) U.S. Cl. CPC A63B 61/00; A63B 61/003; A63B 71/0619; A47K 10/10; G09F 9/30; G09F 23/0066; G09F 23/00

(57) ABSTRACT

Disclosed is a towel rack for use during a tennis or other sports event. In one example, the towel rack includes a support for supporting a towel, and at least one display panel for displaying a message. In a disclosed method, a message is displayed during the sports event, and the towel is placed on the support such that the message is unobstructed by the towel.

### RELATED APPLICATIONS

This application is a continuation-in-part of prior U.S. application Ser. No. 15/957,059, filed on 19 Apr. 2018, which is a continuation of prior U.S. application Ser. No. 14/351,725, filed 14 Apr. 2014, which was a national stage entry of international Application No. PCT/US2012/057403, filed 27 Sep. 2012, which claims the benefit of both U.S. Provisional Application No. 61/546,589, filed 13 Oct. 2011, and U.S. Provisional Application No. 61/564,496, filed 29 Nov. 2011, each of which are herein incorporated by reference in their entirety.

### BACKGROUND

During organized or professional tennis matches, a tennis player uses a towel between most points. Typically, as the player returns to court after the changeover, a ball boy is handed the towel by the player at the far end of the court. The ball boy, in the absence of a dedicated or specified structure, randomly places it somewhere, retrieves the towel when signaled by the player between points, hands it to the player for use, receives it back, where the ball boy again arbitrarily places the towel at a spot at the back of the court, either on some backdrop, a sponsor display, a line umpire chair, a display clock (such as Rolex), or even on the court surface itself, as but a few examples.

The ball boy typically stands in readiness, however, at a location away from the placement of the towel. To retrieve the towel for the player, the ball boy must first run to the line umpire chair before heading to the players, which results in lost time. The ball boy must also return to the ready position outside the playing area as quickly as possible, and therefore has less time to properly place a towel on the chair.

The ball boy is typically also instructed to spread out the towel before handing it to the player, shortening the time the player will need to dry himself off. This may require some delay in handing the towel to the player, as the towel is seldom placed such that it is neatly spread out between points. Even during the same match, at each end of the court, the towel may be in different locations and, as the ball boys are typically rotated, the towel will further be found randomly in more than one spot. In this case, the player will not immediately know which ball boy to signal when the towel is desired, resulting at times in delay between points. The placement of the towel on a line umpire chair also requires the ball boy to maneuver around the line umpire who stands right in front of the chair. The chair may further sit within a closed box, further adding a degree of awkwardness in placing the towel neatly on the chair.

In terms of appearance, a sweat drenched towel in full view of television viewers, often in close ups and lying in rumpled disarray in any of the aforementioned locations, is not aesthetically pleasing and reduces the attractiveness of tennis as a global sport.

Most professional tennis tournaments are played outdoors. Some, such as the Australian Open during summer months, can reach on court temperatures exceeding 40° C. (104° F.). During changeovers, many players require shading from the sun and ice packs, so severe is the effect of the heat. Profuse sweating is a typical result. Heat affected players may take more time between points in order to recover, causing stoppage and delays in play and increasing match length. As climate change continues unabated, these problems pose more of a danger to players' health.

Furthermore, the placement of a towel on a chair results in the line umpires sitting on a chair which had a sweat soaked towel laying upon it, and further results in the players wiping their faces with a towel which was lying on a chair which line umpires sit on during changeovers. In hot weather, this is especially unhygienic.

Finally, as throwing a towel upon a chair or back drop, where it lies in rumpled disarray during play, is not aesthetically pleasing to both live spectators and television viewers, the solution to this problem presents unique advertising opportunities to sponsors and tennis tournaments, as described in the instant application.

### SUMMARY

As towel rack according one non-limiting embodiment of this disclosure includes a support for supporting a towel, and at least one display panel for displaying a message, such as a sponsor message, a time, or some other type of information.

A method according to a non-limiting embodiment of this disclosure includes providing a towel rack having a support and at least one display panel. The method further includes displaying a message on the at least one display panel, and placing a towel on the support such that the message is unobstructed by the towel.

These and other features of the present disclosure can be best understood from the following drawings and detailed description.

### BRIEF DESCRIPTION OF THE DRAWINGS

The drawings can be briefly described as follows:

FIG. 1 is a front-perspective view of an example towel rack.

FIG. 2 is a side-perspective view of the towel rack of FIG. 1.

FIG. 3 is front-perspective view of the towel rack of FIG. 1 with a towel supported thereon.

FIG. 4 is a side-perspective view of the towel rack of FIG. 1 with a towel supported thereon.

FIG. 5 illustrates an optional feature wherein a towel support is configured to rotate.

FIG. 6 illustrates an optional feature wherein a pole is configured generally in an L-shape and is associated with a flexible joint.

FIG. 7 illustrates an optional support feature for the towel rack.

FIG. 8 includes multiple views of another example towel rack.

FIGS. 9a-9b are side-perspective views of the towel rack of FIG. 8.

FIG. 10 is a side-perspective view of another example towel rack including a cooling plate.

FIG. 11 is a side-perspective view of still another example towel rack including a cooling bar and tower.

FIG. 12 is a side-perspective view of still another example towel rack including a cooling coil.

FIG. 13 is a side-perspective view of still another example towel rack including a cooling bar and box.

FIG. 14 is a side-perspective view of still another towel rack including a side display panel.

FIG. 15 is a side-perspective view of still another example towel rack with a rotatable towel support.

FIGS. 16a-16b are front views of an example line umpire chair incorporating a towel rack.

FIGS. 17a-17b are side-perspective views of still another example towel rack wherein the towel support is a towel panel.

FIG. 18 is a side-perspective view of another example towel rack.

FIG. 19 is a side-perspective view of yet another example towel rack.

### DETAILED DESCRIPTION

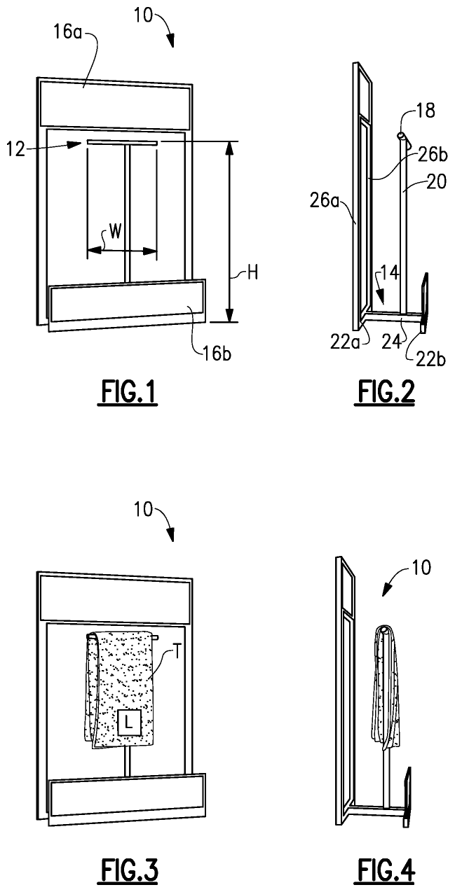

An exemplary towel rack 10 is shown across the various figures. Turning to FIGS. 1-4 in particular, the towel rack 10 includes a support section 12, a base section 14 and a plurality of display panels 16a-16b. In this example, the support section 12 is fastened to the base section 14, which is in turn fastened to the plurality of display panels 16a-16b. This disclosure extends to other types of towel racks, however, including those provided by separate, or separable, components, as will be appreciated from the below description. In one example, the towel rack 10, whether provided by separate components or not, is a dedicated structure for supporting a towel T thereon.

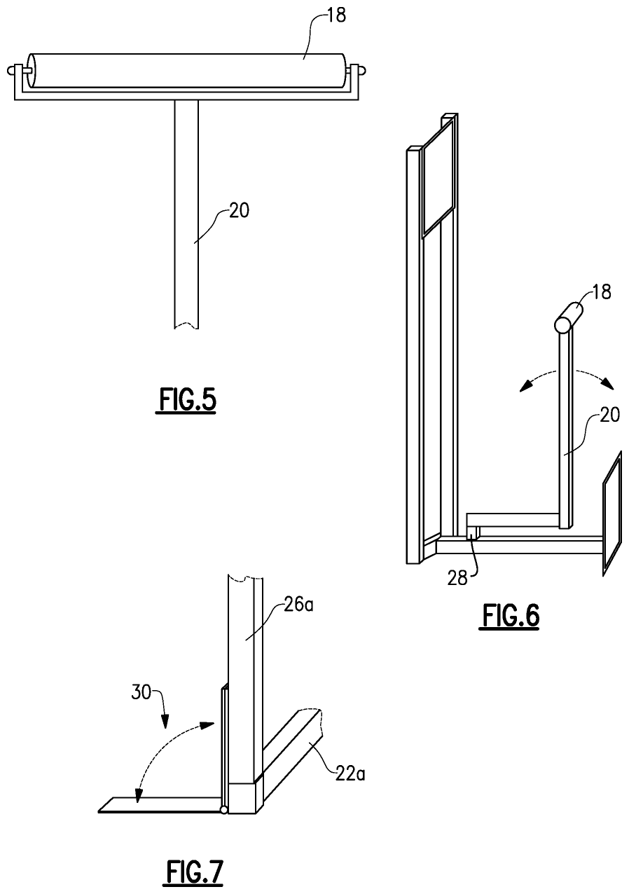

The support section 12 includes a towel support 18, here illustrated as a towel bar, supported by a vertical pole, or post, 20. The towel support 18 is configured to support a towel T thereon. In this regard, the width W of the towel support 18 may be selected to correspond to an expected width of a particular towel T. Further, the height H of the pole 20 may be selected such that the towel support 18 supports the towel T below an upper display panel 16a and above a lower display panel 16b, as illustrated in FIGS. 3-4. In this manner, placing the towel T on the towel support 18 does not obstruct a view of either of the display panels 16a-16b. Further yet, if the towel T itself includes a logo L, the disclosed towel rack 10 allows for simultaneous viewing of the logo L and the display panels 16a-16b, as shown in FIG. 3.

While FIGS. 3-4 show support 18 supported by the vertical pole 20, the vertical pole 20 could act as the towel support 18. To this end, the towel support 18 could be arranged in any manner (either perpendicular, parallel, vertical, horizontal, etc.) as one would appreciate from below. In other words, the support 18 is not limited to any particular orientation.

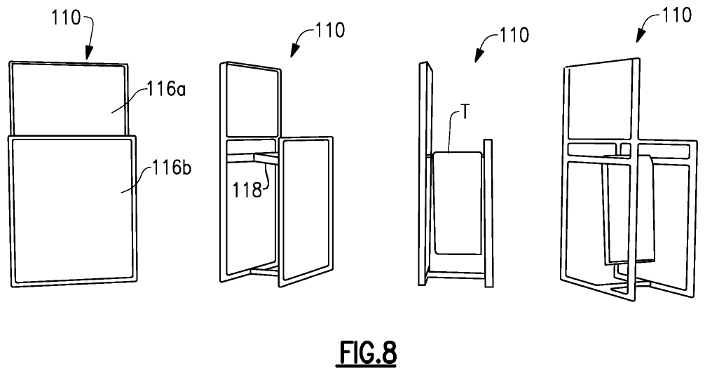

It is possible to configure the towel support 18 such that it rolls, or spins, about its long axis relative to the pole 20, as illustrated in FIG. 5. In this case, the chances of snagging the towel T on the towel support 18 or on the pole 20 during towel removal are reduced. A feature may be added to adjust the resistance of the towel support 18 to rotation, to allow a user to select a desired rotatability. In a further feature, the towel support 18 could be made of a rubber material which would prevent the towel T from slipping off in the event the towel T is not positioned evenly across the towel support 18.

Turning back to FIG. 2, the example base section 14 includes a plurality of lateral base supports 22a-22b, as well as a transverse base support 24, each of which works to provide the towel rack 10 with stability. While only one transverse base support 24 is shown, additional transverse supports can be included. In general, however, the lateral supports 22a-22b serve to prevent side-to-side tipping of the towel rack 10, whereas the transverse support 24 generally prevents tipping in a front-to-back direction. Further, rubber feet could be attached to the base section 14, increasing the stability thereof.

As one would appreciate, the dimensions of the towel rack 10 may affect the stability and functionality of the rack. For example, the length of the transverse base support 24 may be selected such that it is proportional to the height H of the towel support 18 and the display panel 16a. Further, pole 20 may be positioned offset from the display panel 16b, which will further add front-to-back stability to the towel rack 10, however the pole 20 should be positioned so that there is no obstruction in quickly placing the towel T on the towel support 18.

Turning to FIG. 6, an alternate pole 20 arrangement is illustrated. In this example, the pole 20 is connected further back on the transverse base support 24, but is provided with an “L-shape” such that the towel support 18 is in the same relative position as in the example of FIG. 1. This further increases the front-to-back stability of the towel rack 10. The pole may further include a flexible joint 28 such that any great tug would have the force projected into the joint 28 before working to tip the towel rack 10 over. Optionally, the entire pole 20 may be flexible.

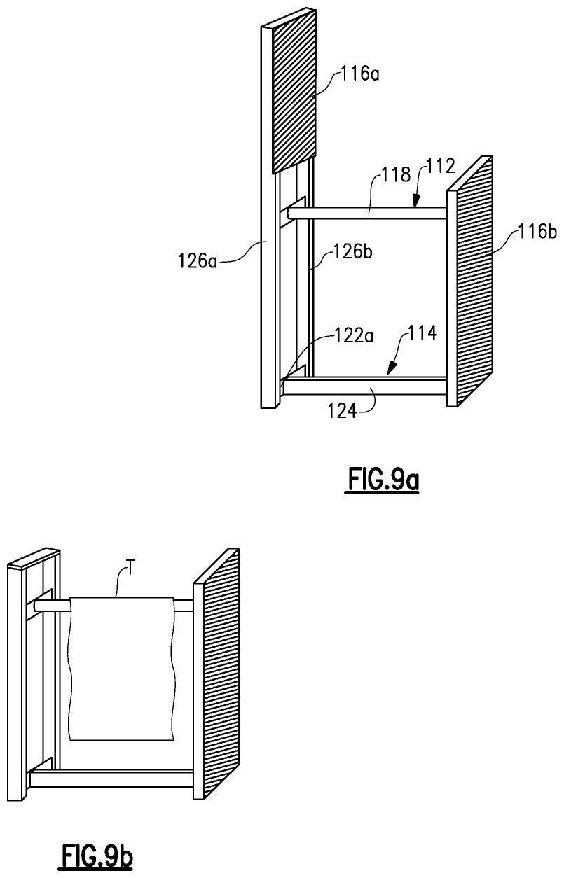

The base section 14 provides the towel rack 10 with the stability to be a freestanding, mobile structure. That is, the towel rack 10 is not required to be permanently fixed to any larger structure for support, although it can be if desired. For example, the base section 14 may be provided with any locally available additional weights (e.g., such as water bottles or sand bags), or may be affixed (e.g., by way of screws or the like) to a surface (such as a wall, floor, or the tennis court itself) for added stability. Towards this, back supports 30, which may include rubber, may be hingeably connected to vertical display supports 26a-26b to slide under a backdrop or wall, or to support a counterweight thereon further increasing rack 10 stability, as generally illustrated in FIG. 7. It is also possible to make the entire towel rack 10 out of a material such as steel, with sufficient weight to provide the needed stability. It is further possible to make the base section 14 out of a material heavier than the remainder of the towel rack 10.

Upper and lower display panels 16a-16b may be configured, as explained above, to be positioned above and below the towel T when the towel T is placed on the towel support 18 but offset vertically, for the reasons as previously described. Vertical display supports 26a-26b may extend upwardly from a rear lateral base support 22a to support the upper display panel 16a. The lower display panel 16b, in the example, is positioned directly above a front lateral base support 22b. This way the towel T does not block viewing of either display panel 16a-16b. The display panels 16a-16b may display a message (here shown as a sponsor message including a corporate logo), such as an advertisement, or any other type of message. By way of an additional example, third and fourth display panels could be placed laterally to the base section 14 (as generally illustrated in FIG. 14), further increasing potential sponsor revenue. Additional display panels may be added to the towel rack 10 as desired.

It will be appreciated that the term “message” includes sponsor messages, and can further include messages such as the time of day, a length of time of a tennis match, a speed of a serve of a tennis ball, and any other relevant information that event organizers desire to convey to spectators, as examples. “Sponsor message,” as used herein, includes a name, logo, advertisement, photo, etc., which promotes or represents a company, product, service, or brand name, generally for marketing or publicity purposes. In other words, the message could include at least one of (1) a sponsor message, (2) the time of day, (3) a length of time of a tennis match, and (4) a speed of a serve of a tennis ball. The message could further include a shot clock, or some other type of indicator providing information regarding the match.

Further, the vertical display supports 26a-26b may be hingeably connected to the base section 14 so as to increase the stability of the rack 10, and to direct the display panel 16a upwardly for increased viewing, if desired.

Additionally, the front display panel 16b may be larger than in the example shown, such that the display 16b completely obscures the view of the towel T from a front perspective, as illustrated in FIG. 8. In some instances, it may be preferred to essentially hide the towel T behind the display panel 16b (e.g., for aesthetic reasons).

Given that the towel rack 10 may be positioned on a tennis court during play (e.g., the towel rack 10 may be placed on the court and near, but spaced from, the playing area), both in-person and television spectators of the tennis match may be capable of viewing the display panels 16a-16b. Although the display panel 16a-16b may be relatively small in size (relative to typical advertisements associated with tennis matches), the relative visibility may be pronounced as a camera zooms in on a particular player between points, or as the camera tracks the ball boy as he gives the player his towel. The display panels 16a-16b could include LED screens, or other types of electronic display screens, or a display of the rotating variety for changing the display between games/sets. Further, the display panels could be boards, stickers, or any other type of panel configured to be removed from the towel rack 10 and replaced as needed, and need not be electronic screens.

In general, the towel rack 10 is configured for outdoor use to withstand wind and rain. As mentioned, the towel rack 10 may be made of steel, and can be further made of materials such as aluminum, plastic, carbon fiber, or any other suitable material. If a lightweight material is selected for the towel rack 10, additional weights can be added to the base section 14 (as generally noted above). This way, the towel rack 10 maintains the required stability when it is free standing.

Again, the disclosed towel rack 10 may be used on, or near, a tennis court during a tennis match. In particular, the towel rack 10 may be positioned near a ball boy at the far end of the court, or even near a player bench. In general, one may select a location for the towel rack 10 depending on the desired towel rack 10 visibility. In one example, the towel rack 10 is placed outside the doubles line of a tennis court, which is typically where the ball boys stand during points (so that they do not interfere with the line judges). Thus, the towel T will be well away from any playing area. This also puts the towel T in a consistent place where the ball boy knows to retrieve it, allowing for a speedier retrieval and possibly quicker play.

Accordingly, the disclosed towel rack 10 keeps a towel in a tidy fashion between points, while reducing the time and energy required to place and subsequently retrieve the towel (as the towel will be located in a single, convenient location). Spread out on the towel rack, the towel will stay fresher and dry quicker and therefore function better to absorb sweat for the players. Further, the incorporation of one or more of the display panels 16a-16b serves as an additional revenue generator for a tennis tournament, for example. It is possible that two towel racks will be used for each match (one for each player at each side), potentially adding to the promotional/advertising benefits of the display panels 16a-16b.

While the towel rack 10 has been discussed relative to the sport of tennis specifically, it is to be understood that this towel rack may be used with other sports outside of tennis, and may be used outside the world of sports altogether.

To the extent not otherwise described or shown, the embodiments illustrated across FIGS. 8-17a corresponds to the embodiments of FIGS. 1-7, with like parts having reference numerals preappended with a “1,” unless specified otherwise below.

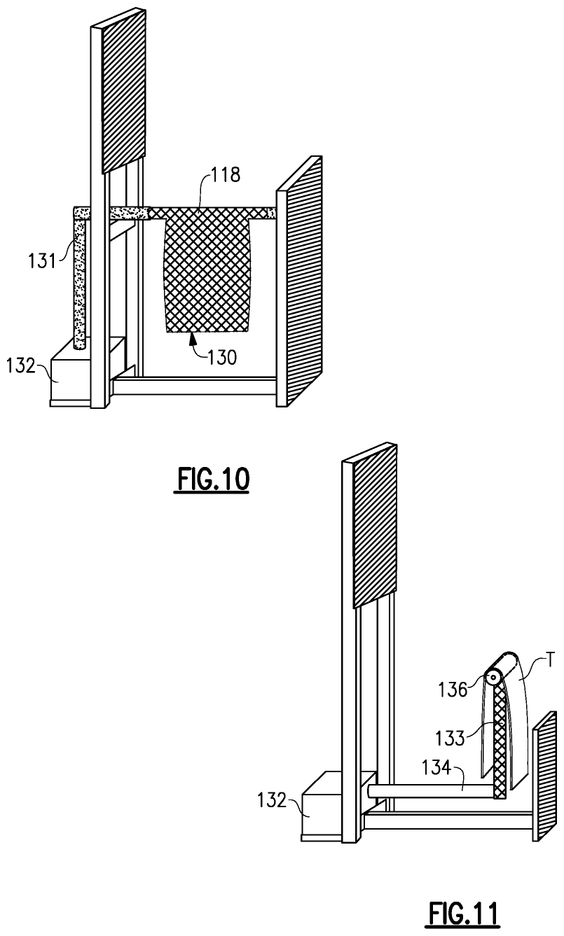

Turning to FIGS. 8-9b, a towel rack 110 includes a support section 112, a base section 114 and preferably a plurality of display panels 116a-b, which in this example are electronic display panels.

The support section 112 includes a towel support 118 supported above the base section 114. The towel support 118, here illustrated as a bar, is configured to support a towel T thereon in a position generally perpendicular to the display panels. In this regard, the width of the towel support 118 may be selected to correspond to an expected width of a towel T. In some configurations, as seen in FIG. 8, the front display panel 116b is of an increased size which will largely hide the towel T. This achieves at least three functions.

First, it allows for a larger and more visible display, increasing the potential value and revenue with regards to sponsors. Second, it will largely keep the towel T discretely out of public view during play, which may be considered to be of aesthetic value. And third, it allows for an increased stability by virtue of the towel support 118 being perpendicular to, and connecting, the back support to the front display panel.

The electronic displays 116a-16b could be separate screens showing separate images or, for example, could be synchronized to show one large image. Suitable electronics may be added to allow for the electrical requirements of the screens, including as well a remote or Bluetooth connection (or other wireless connection) to allow remote control of the brightness and/or video images which would be required during play.

The towel support 118 in its perpendicular orientation can further allow a ball boy, say, to more easily throw the towel over the towel support 118 from the side position, where the ball boy would normally stand after retrieving the towel from the player prior a new point commencing.

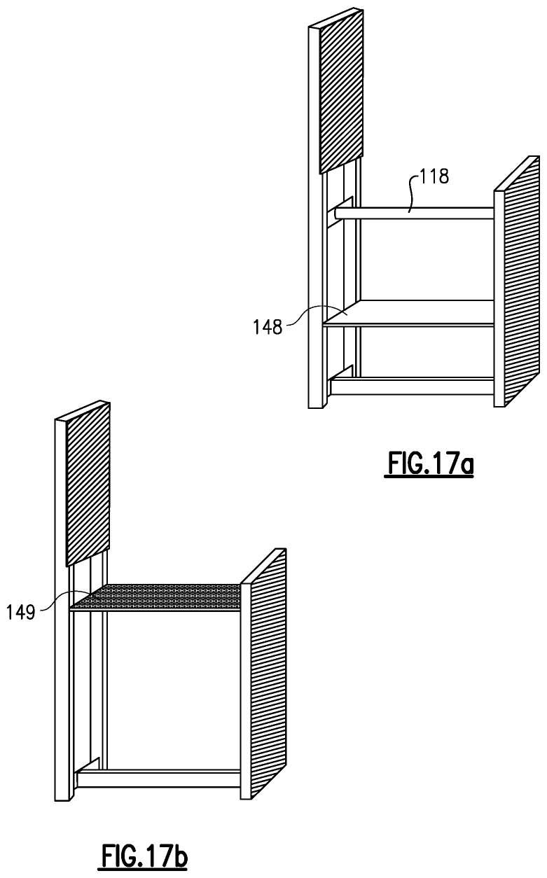

It will be appreciated that the structure supporting the towel may be of any shape and need not specifically be described as a single bar. The towel support 118 can be duplicated into a double bar, for example, which via greater exposed towel surface area would provide for quicker drying, as well as a wider target for quickly placing the towel. There can also be a net between the two bars which would catch the towel if the ball boy is unable to place the towel with enough care that it would not slip or fall off the towel support(s). Other examples could be a box, basket or a flat panel located below, or alternatively in place of, the towel support 118. Broadly speaking, the towel support may be any structure which can receive the towel for placement in between the player's use of the towel A further example for the towel support is a generally flat towel panel 149, as shown in FIG. 17b, and generally discussed below.

FIGS. 9a and 9b show the display panels as being preferably an electronic screen, which would allow more visible logos, as well as actual advertising videos or animated logos prior to the match start and during the changeovers. As the changeovers are 90 seconds, multiple sponsors could be obtained for the same stand, as the electronic panel could show, for example, three sponsors at 30 second intervals or, in the alternative, one sponsor per a predetermined number of games, further increasing revenue opportunities. The front display panel is of a height allowing two separate screens in the normal 16:9 dimension or one large screen positioned vertically. Where it is not preferred to have a higher structure 116a for example, the rack can include only the front display panel 116b, as illustrated in FIG. 9b.

It should be appreciated that the towel rack could be of any particular size and dimension, incorporating one or multiple display panels, in accordance with the specific needs of the tournament and the court upon which it will be located. A center court may require electronic display panels while an outer court, normally untelevised, may require only printed display panels. A combination of both electronic and printed display panels within the same towel rack may also be preferable, and where electronic display panels are employed, a Plexiglas sheet (or the like) may be used to protect the screen.

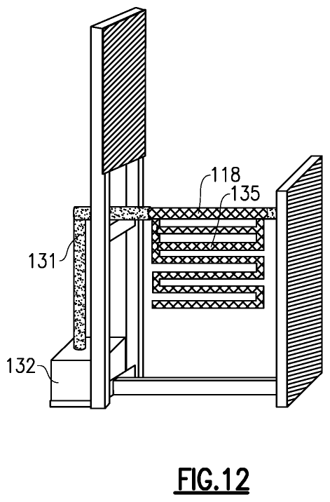

FIG. 10 shows a cooling plate 130, incorporating (and may replace) towel support 118, which serves as a cooling surface and upon which the towel is placed. The refrigeration system 132 could provide cooling via pipes 131. Additionally, a blowing function could be added to cause air to blow out of the multiple openings in cooling plate 130 which would further cool the towel, as well as dry it. Such a feature during play in hot temperatures would provide relief to players (who otherwise need to wait until the changeover in order to use an ice pack). Any such respite would improve play as well as protect players from heat exhaustion.

FIG. 11 shows another configuration of a cooling system, whereby the cooling structure is the vertical post 133, together with towel support 136, which receive cool air from a refrigeration system 132 via a pipe 134. The cold air would blow out of the small openings of bars 133 and 136, cooling the towel T. While this solution is shown relative to a parallel towel support 136, it could be incorporated into the embodiments of FIGS. 8-10 and 12-14, in which the towel support 118 is positioned generally perpendicular to the display panels 116a-16b. As will be appreciated from the figures, at least the front display panel 116b obscures the view of the cooling system from a front perspective.

FIG. 12 shows a variation whereby the cooling plate is in the form of a coil 135, not unlike coils commonly found in bathrooms used to heat towels. Here, however, the coil serves to cool, not heat, the towel. The coil may preferably have openings to allow the escape of cool air on to the towel, as performed by a blowing structure within or separate from refrigeration system 132.

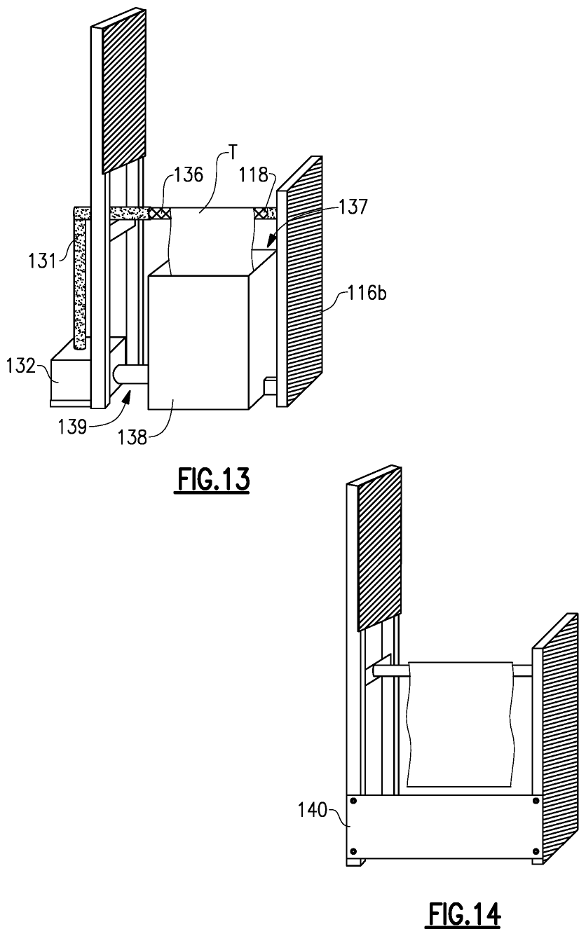

FIG. 13 shows yet another cooling configuration, whereby the towel T, in addition to being cooled by bar 136, as a part of towel support 118, via refrigeration system 132, will fall within a cooling box 138 or container, as fed via pipe 139. The walls of the cooling box 138 may contain small openings allowing cool air to be blown through by an air blower which circulates the cold air. An air blower outlet or fan within the cooling box 138 will contribute further to cooling down the towel by blowing the cold air at the bottom of the box upwards and unto the towel. A multiple of bars or any wider support could also be employed so that the towel is spread out wider, allowing more of the inside surface area to be reached by the cool air. The front display panel 116b is positioned and of a size where the cooling box 138 is hidden from view, especially to television viewers where the camera angle is typically from the end of the court. The cooling box, as seen by some spectators in the stadium or side camera angles, can have a logo visible on its side or a side display panel can separately conceal the cooling box 138. Further, means can be fitted to hold water, which would of course be held in a fluid container, within the cooling box 138 for either ball boys (who are typically youths more prone to dehydration) or even players to quickly sip cool water in lieu of toweling off (in light of the 120 second time allotted between points). The water could be kept accessible in any of the configurations across FIGS. 8-15. It will be appreciated that the box 138 may be employed alone as the towel support and/or in a general configuration need not be cooled.

FIG. 14 shows a side panel 140 which allows for further sponsor signs in addition to the display panels 116a and 116b. This side panel can be duplicated on both sides of the stand or just one side. It may be of any size, whether to allow view of the towel or to conceal it. The side panel 140 may be positioned slightly off the ground so that a ball boy's feet will be less likely to knock against the side panel 140 when placing the towel T on the towel support 18 from the side. Additionally, the side panel 140 could be hinged at one end, allowing them to be moved into, for example, a 45° angle to the back and front displays.

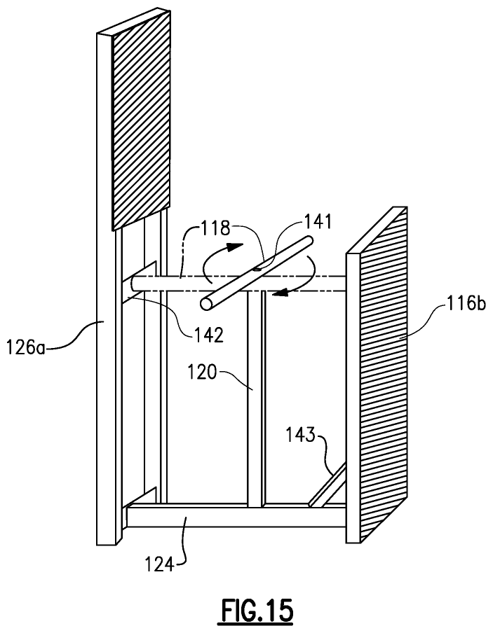

FIG. 15 shows towel support 118, as resting on support 120, which can be rotated to any position, preferably parallel or perpendicular to the display panels 116a and 116b, upon connector 141. By having the towel support 118 in the parallel position, the depth of the towel rack structure can be reduced substantially in circumstances where available space is limited. The bar 118, when in the perpendicular position, may be easily fixed to the back support for display panel 116a and to the back support for display panel 116b, for added stability during use or transport. Connector 141 allows for the bar 118 to click into place to secure its connection in at least the parallel and perpendicular positions (again relative to the display panels 116-116b). Support 143 may be used in various places to further provide stability for the electronic screens or printed signs. During transport, in order to position the towel rack 10 on court, wheels and/or brakes may be fitted to the towel rack 110 for ease of transportation. Furthermore, to increase stability, the front display panel 116b could be angled slightly backward (to a more acute angle with support 124) so as to work against it potentially tipping forward. This could actually improve the viewing angle since most speculators in the stadium and the televised camera angle are typically from high up.

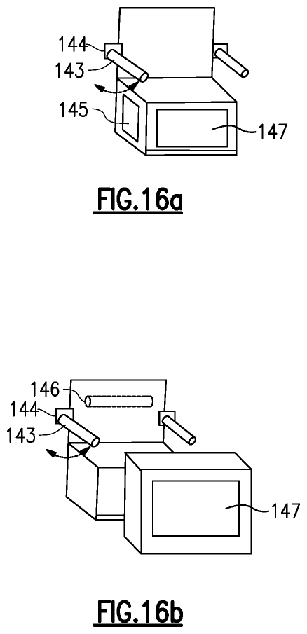

In FIGS. 16a-16b, the towel rack is shown incorporated into a line umpire chair. Towel supports 143, which can also act as an arm rest, can hold a towel. In order that the line umpire may sit on the chair, towel support 143 may swivel out upon hinge 144. Sponsor logos may be placed on the back or sides of the chair, as shown display 145. Additionally, a bar, box or basket can be attached to or positioned behind the back of the chair in circumstances where the ball boy assesses the time required to lay the towel over the towel support 118 as being too short, and therefore can quickly throw the towel into the receptacle. Towel support 146 may be placed on the back side of the chair or on the back side of the front display panel 147. It will be appreciated that particular elements of the towel rack ensemble can be detachable, however still retaining their function in the entirety of the invention. Moreover, in each of the configurations described herein, each element need not be physically connected in order to be a part of the invention. By way of example, the display screen for reasons of convenience need not be physically connected (i.e. mechanically attached, for example by bolt, hinge or screws) to the towel support in order to comprise the instant invention if the elements work together to perform the function as described herein.

FIG. 17a shows the towel rack with a lower towel panel which can be used to catch a towel which might fall off the towel support 118 if placed too hastily by the ball boy. FIG. 17b shows a towel rack which the towel panel is used with or in place of a towel support 118. Towel panel 149 may have small holes or slots, or can be a net or basket, so that the underside of the towel will be exposed to air, further facilitating drying.

FIG. 18 illustrates a towel rack 210 according to another aspect of the present disclosure and in particular includes a disinfection feature configured to improve hygiene by disinfecting the towel T while it is on the towel rack 210. The towel rack 210 of FIG. 18 is arranged substantially as shown in FIG. 9a except where otherwise mentioned below. That said, it should be understood that the disinfection feature discussed below could extend to any of the towel racks discussed in this disclosure. For example, while one display panel is shown in FIG. 18, the disinfection feature is not limited to towel racks with one display panel. In fact, the disinfection feature could extend to towel racks without any display panels.

To the extent not otherwise described or shown, the towel rack 210 corresponds to the embodiments of FIGS. 1-17b, with like parts having reference numerals preappended with a “2,” unless specified otherwise below.

In FIG. 18, a towel T is placed on the towel support 218. When on the towel support 218, the towel T is exposed to a disinfector 270. The disinfector 270 is shown schematically in FIG. 18 and is mounted to a frame of the towel rack 210. The disinfector 270 may be mounted at a location other than what is shown in FIG. 18.

The disinfector 270 may be operable in response to commands/instructions from a control unit C and/or in response to a signal from a sensor 272 mounted adjacent the towel support 218 and configured to generate a signal indicative of the towel T being placed on the towel support 218. The control unit C may disable the disinfector during a changeover of a tennis match, during which time the towel T is highly unlikely to be on the towel rack 210. The control unit C is illustrated schematically and is a known type of control unit configured to receive signals and issue instructions/commands in response to those signals. The control unit C includes hardware and software necessary to command operation of the disinfector 270.

The disinfector 270 may be one of a number of types of disinfectors configured to improve hygiene by killing germs and/or bacteria. In particular, the disinfector 270 may be a UV light such as a UV-C light, a silver ion infuser, an antimicrobial spray such as commercially available fabric refresher (e.g., such as Febreze®), and/or antimicrobial textiles (e.g., including but not limited to those with silver ions). While only one disinfector 270 is shown in FIG. 18, multiple disinfectors of the same type or different types could be incorporated into the towel rack 210. The disinfector 270 may also have a synergistic effect when used with one or more of the cooling systems discussed above (i.e., FIGS. 10-13) because lower temperatures and low humidity reduces the growth of bacteria. That said, the disinfector 270 does not need to be used in conjunction with a cooling system.

Further, in this example, the front display panel 216b of the towel rack 210 is fully visible from at least a front perspective, specifically from a tennis court in one example. The front display panel 216b is sized and arranged such that it obscures a vast majority of the view of the towel T, if not the entirety of the towel T, from the front perspective when the towel T is placed on the towel support 218. The front display panel 216b is also sized and arranged to obscure a majority if not the entirety of the view of the disinfector 270 from the front perspective. This aspect of the disclosure improves aesthetics and keeps the focus on a sponsor message displayed on the front display panel 216b.

During a professional tennis match, the towel T is generally handled by both a player and a ballkid. The ballkid typically brings the towel T to the player and then takes it back from the player to place back on the towel support 218. The risk of the towel T being contaminated by germs is not insignificant. Players may still play despite having some sort of infection (e.g., a cold or flu) and sometimes even blow their nose into the towel T, risking infecting the ball kid. Conversely, as most ball kids are teenagers, who as a group are frequently sick, there is the risk of infecting the player. If the player were to fall ill, it may have a negative impact on many stakeholders in a tournament, including the player, his sponsors, the tournament, fans, etc. The disinfector 270 prevents the spread of germs thereby increasing overall hygiene for players, ballkids, and anyone else that may come into contact with the towel T.

A dispenser of hand sanitizer, such as gel or foam, may be incorporated into the towel rack 210 to further increase hygiene.

The towel T may also include antimicrobial properties configured to resist the spread of germs. The towel T could undergo a treatment such as being coated or infused with silver ions either during manufacture, before a tennis match, during a tennis match, or after a tennis match such that it exhibits antimicrobial properties, as examples. The towel T may include a material reactive to certain wavelengths of light and which, when exposed to such light, provides a disinfecting effect.

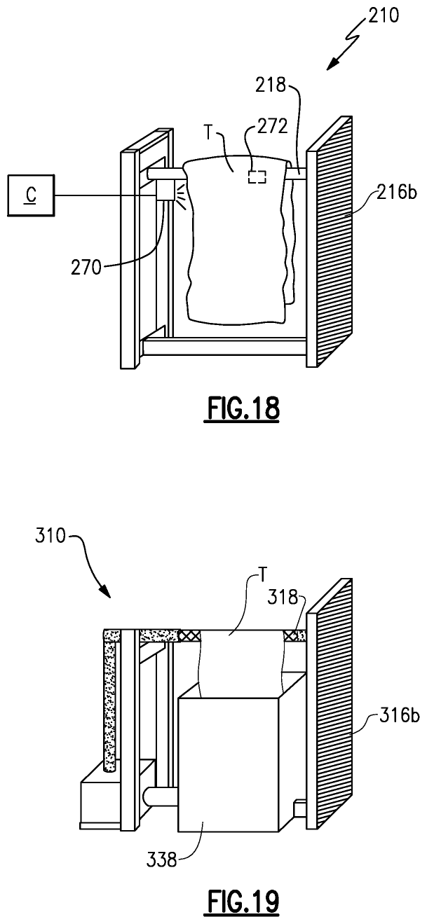

FIG. 19 illustrates yet another example towel rack 310. To the extent not otherwise described or shown, the towel rack 310 corresponds to the embodiments of FIGS. 1-18, with like parts having reference numerals preappended with a “3,” unless specified otherwise below.

In FIG. 19, a disinfector similar in function to the disinfector 270 could be mounted to the towel support 318 or could be integrated into the towel support 318. For instance, the towel support 318 could include a UV-C light bulb embedded into the towel support 318. The towel support 318 could also include orifices or apertures configured to emit an antibacterial mist. A sensor similar to the sensor 272 could also be incorporated into the towel support 318.

Box 338 is configured to surround at least a portion of the towel T and could additionally or alternatively include a disinfector similar in function to the disinfector 270. The box 338 could also include a fan configured to circulate air and/or other fluids within the box 338, including, if present, a disinfecting agent, such as an antibacterial mist. The towel support 318 and/or the box 338 may be sized and arranged such that the towel T is entirely within the box 338 when placed on the towel support 318. A disinfection cycle may run within the box 338 when the towel T is not present.

While in one example the towel rack is positioned at the rear of a tennis court where the ball boy typically stands, the towel rack may be positioned at other locations, including for example adjacent to the players' benches/chairs on either side of the chair umpire.

Although the different examples have the specific components shown in the illustrations, embodiments of this disclosure are not limited to those particular combinations. It is possible to use some of the components or features from one of the examples in combination with features or components from another one of the examples. As previously discussed, each element need not be physically attached/connected and may also be employed in close proximity in order to achieve the same function.

One of ordinary skill in this art would understand that the above-described embodiments are exemplary and non-limiting. That is, modifications of this disclosure would come within the scope of the claims. Accordingly, the following claims should be studied to determine their true scope and content.

1. A towel rack for use during a sports event, comprising:
a disinfector configured to disinfect a towel placed on the towel rack.

2. The towel rack as recited in claim 1, wherein the disinfector includes at least one of UV light, a silver ion infuser, an antimicrobial spray, and antimicrobial textiles.

3. The towel rack as recited in claim 2, wherein the disinfector includes a UV-C light.

4. The towel rack as recited in claim 2, wherein the disinfector is activated when a towel is placed on a towel support of the towel rack.

5. The towel rack as recited in claim 4, further comprising a sensor mounted adjacent the towel support and configured to generate a signal indicative of the towel being placed on the towel support.

6. The towel rack as recited in claim 4, further comprising a display panel configured to obscure a view of a vast majority of the towel when the towel is placed on the towel support from at least a front perspective.

7. The towel rack as recited in claim 6, wherein the display panel completely obscures both the towel and the disinfector from at least the front perspective.

8. The towel rack as recited in claim 7, wherein the display panel is configured to display a sponsor message in a direction of a playing surface of a tennis court.

9. The towel rack as recited in claim 2, further comprising a cooling system configured to cool the towel.

10. The towel rack as recited in claim 9, wherein the cooling system is configured to blow air relative to the towel.

11. The towel rack as recited in claim 1, wherein the towel rack includes a dispenser of hand sanitizer.

12. A method, comprising:
disinfecting a towel placed on a towel rack during a tennis match.

13. A method, comprising:
applying a material to a towel, wherein the material exhibits antimicrobial properties, wherein the applying step is performed during manufacturing of the towel, prior to a tennis match, or during a tennis match; and
placing the towel on a towel rack during the tennis match.

14. The method as recited in claim 13, wherein the material includes silver ions.

15. The method as recited in claim 14, wherein the applying step includes infusing the towel with silver ions.
